(19) United States
(12) Patent Application Publication
(10) Pub. No.: US 2007/0210672 A1
(43) Pub. Date: Sep. 13, 2007

(54) Brush card assembly with add-on EMI suppression card

(76) Inventors: David C. Fleminger, Owosso, MI (US); Patrick D. Phillips, Owosso, MI (US)

Correspondence Address: JAECKLE FLEISCHMANN & MUGEL, LLP, 190 Linden Oaks, ROCHESTER, NY, 14625-2812, US

(21) Appl. No.: 11/374,271

(22) Filed: Mar. 13, 2006

(51) Int. Cl. H02K 11/00; H01R 39/38

(52) U.S. Cl. 310/239; 310/68 R

(57) ABSTRACT

An additional board having an electrical device such as an EMI suppressor is attached to the underside of a brush card with the electrical device coupled to the input power to the brush card. The additional board has a plurality of conductive regions, and in some embodiments one of the conductive regions makes contact with the metallic support of the brush card. The input power wires can be crimped onto metallic terminals that are riveted to the brush card in a manner to rivet the additional card to the brush card and to conduct the input power to the additional card. One of the metallic terminals can be a metallic strip jumper that is at least partly under the brush card to connect to a device mounted to the top of the brush card that is separated from the power input wires by a brush holder.

### TECHNICAL FIELD

The present invention relates in general to a brush card assembly for use in permanent magnet DC motors, and, more particularly, to a brush card assembly having an add-on printed circuit board for EMI suppression.

### BACKGROUND OF THE INVENTION

DC motors often require some type of electromagnetic interference (EMI) suppression for the electrical noise generated by the brushes and commutator to block the electronic noise emitted from the motor that interferes with radio transmission or the function of other electronic devices. There are a number of methods to achieve different levels of EMI suppression, the most common being one or more capacitors installed in the motor's electrical circuitry.

FIG. 1 shows a top perspective view of a prior art brush card 10, enclosed in an end cap 14, to which has been mounted two brush tubes, 16 and 18, which hold brushes 20 and 22, respectively. The brushes 20 and 22 are urged toward a central hole 24 in the brush card by brush springs 26 and 28. Also mounted on the brush card 10 is a circuit breaker 30 and a conductive metal region 32 having two through holes 36 and 38. Placed in through hole 36 is a wire 40 which connects the metal region 32 with a first terminal of the circuit breaker 30. Placed in the second through hole 38 is a first lead of a capacitor 42 and one end of a power input wire 44 which is routed into the motor through a rubber grommet 46. A second power input wire 48 passes through the grommet 46 and into a brass eyelet 50 into which is placed the second lead of the capacitor 42 and the pigtail wire 54 of the brush 20. The pig tail wire of the brush 22 is connected to a second terminal 56 of the circuit breaker 30. The brush card assembly of FIG. 1 is partially assembled with further assembly remaining to be completed by wedging the tops of four staking posts 58 to secure the brush card 10 to the end frame 14, by crimping and soldering the through holes 36 and 38 and the brass eyelet 50, and by securing the capacitor 42 in place with an adhesive.

The manufacture of the assembly of FIG. 1 requires an assembly person to manually place the wires and capacitor which are to be soldered onto the brush card, and these components must be held in place during the soldering operation. It is also critical that the wire 40 be correctly positioned so that it doesn't interfere with the armature when the motor is assembled. Moreover, a line of motors using the same brush card may be used in different environments in which the capacitor 42 is sufficient EMI suppression, and in other environments the single capacitor is insufficient and additional capacitors may be required. Placing the additional capacitors on the brush card complicates the assembly process.

It is a principal object of the present invention to provide a brush card assembly which can easily be modified to provide different types of EMI suppression.

### SUMMARY OF THE INVENTION

Briefly described, a brush card assembly has a main brush card with a plurality of brush holders attached to the top of the main brush card and an additional board attached to the bottom of the main brush card.

Also described is a method of providing EMI suppression to an electrical motor by attaching an EMI suppressor device to a circuit board having a plurality of conductive regions and attaching the circuit board to the bottom of a main brush card in a manner to couple the input power voltage to the motor present on the main brush card to the circuit board.

### BRIEF DESCRIPTION OF THE DRAWINGS

These and other features and advantages of the invention will be more fully understood and appreciated from the following description of certain exemplary embodiments of the invention taken together with the accompanying drawings, in which:

FIG. 1 is a perspective view of a prior art brush card and end cap;

FIG. 2A is a perspective view of a bottom portion of a main brush card with an additional board that is one embodiment of the present invention;

FIG. 2B is a perspective view of a bottom portion of a main brush card with a second alternative additional board that is another embodiment of the present invention;

FIG. 2C is a perspective view of a bottom portion of a main brush card with a first alternative additional board that is another embodiment of the present invention;

FIG. 3 is a perspective cross section view of a bottom portion of the main brush card of FIG. 2A and the additional board of FIG. 2A mounted in an end cap;

FIG. 4 is a perspective view of an upper portion of the main brush card of FIG. 2A in an end cap with additional components mounted on the main brush card;

FIG. 5 is a perspective view of an upper portion of another main brush card with the additional board of FIG. 2A and a modified brass terminal mounted on the brush card;

FIG. 6 is a perspective view of a bottom portion of the main brush card and additional card of FIG. 5; and

FIG. 7 is a perspective view of an upper portion of a third main brush card with the additional board of FIG. 2A secured thereto and an alternate end cap.

It will be appreciated that for purposes of clarity and where deemed appropriate, reference numerals have often been repeated in the figures to indicate corresponding features, and that the various elements in the drawings have not necessarily been drawn to scale in order to better show the features of the invention.

### DESCRIPTION OF THE PREFERRED EMBODIMENTS

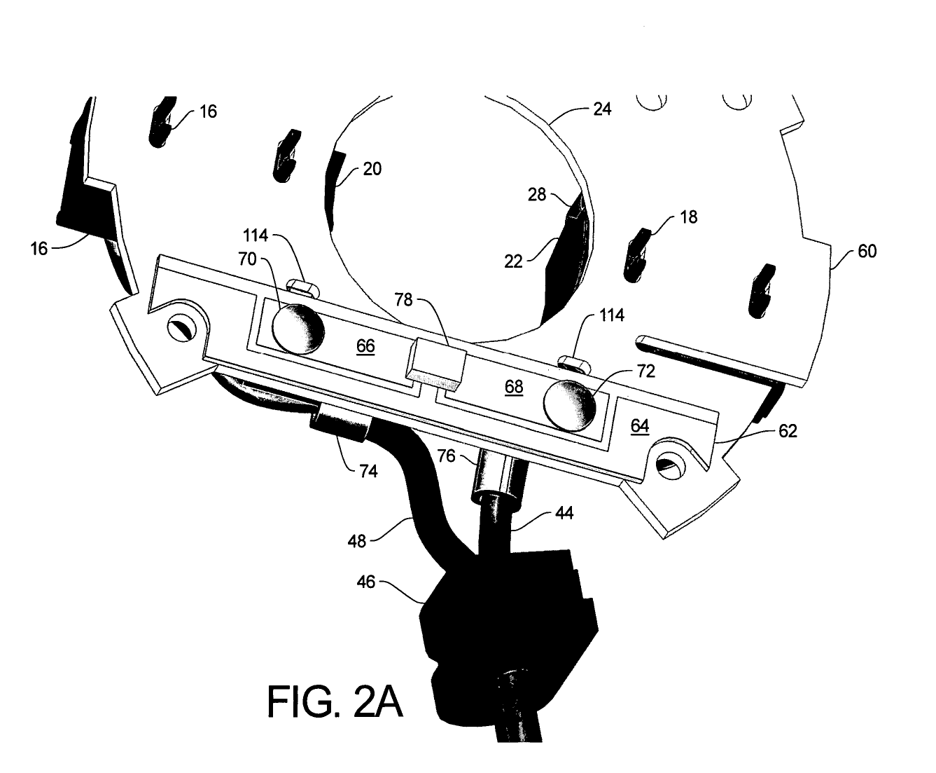

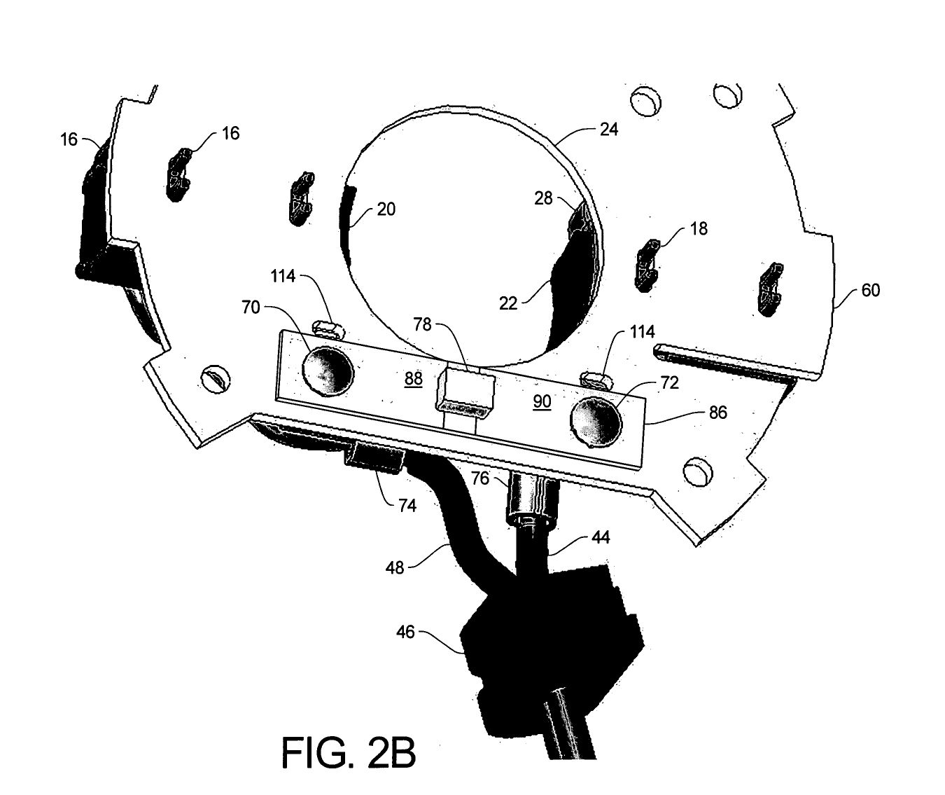

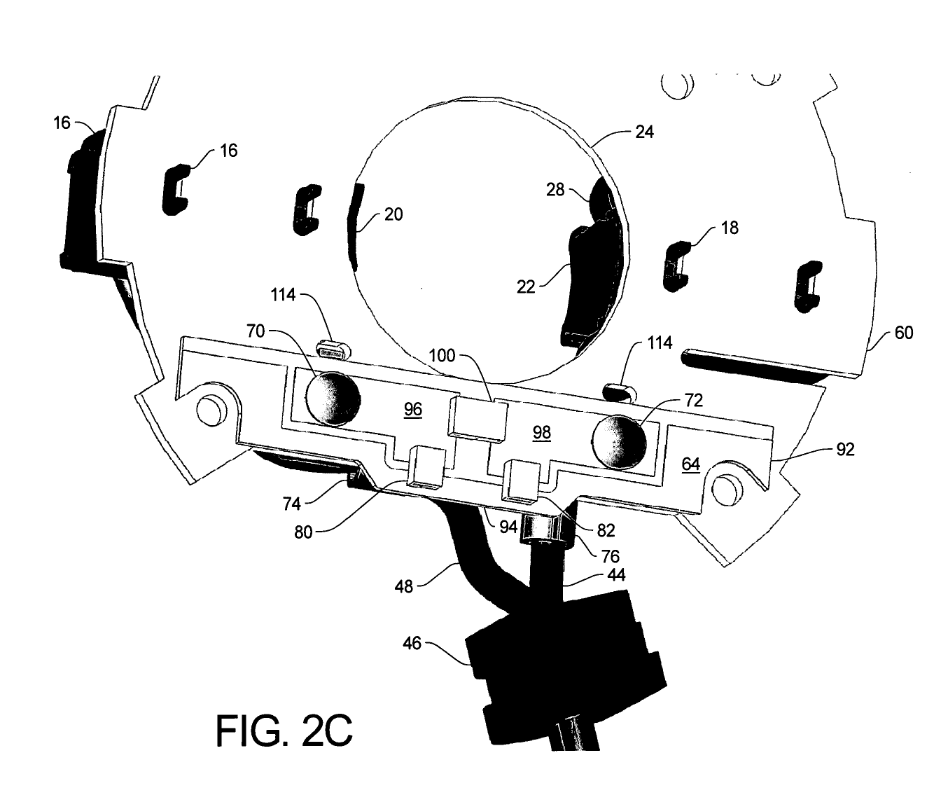

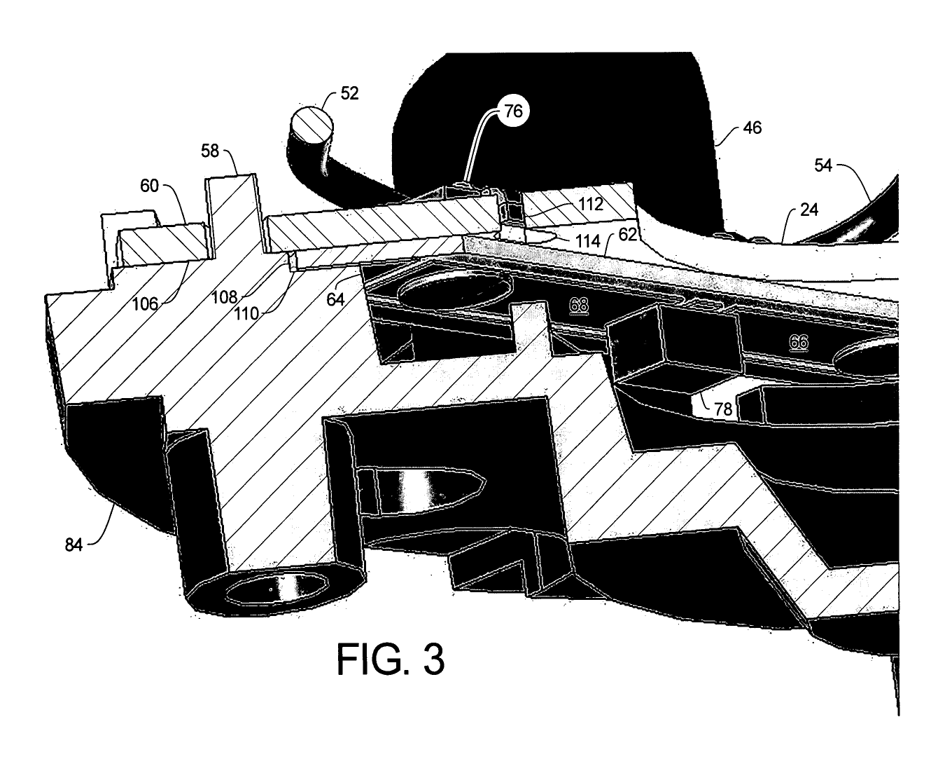

Turning now to FIG. 2A, a perspective view of a bottom portion of a main brush card 60 with an additional board, such as an EMI card 62, and other components that are an embodiment of the present invention is shown. The EMI card 62, a printed circuit board (PCB) in the preferred embodiment, is manufactured separately from the brush card 60. The EMI card 62 has three metallization regions 64, 66, and 68. Metallization regions 66 and 68 have through holes which are covered in FIG. 2A by the heads of the rivets 70 and 72, respectively, which secure the EMI card 62 to the main brush card board 60. The rivets 70 and 72 also provide electrical contacts to the power input wires 48 and 44, respectively. The power input wires 44 and 48, rather than being soldered to the main brush card 60, are crimped onto brass terminals 74 and 76, respectively, as more clearly shown in FIG. 3. An EMI suppression device 78 is attached to and electrically connected to the metallization regions 66, 68 and 64 in this configuration. Region 64 provides a ground path from the device to the end cap casting 84. The EMI suppression device 78 can be a two terminal device such as a capacitor or a more complex integrated type of EMI suppressor such as a X2Y EMI suppressor manufactured by X2Y Technology of Erie, Pa.

In operation the EMI card 62 electrically couples the two input power leads 44 and 48 to each of two terminals of an EMI suppression device 78.

As shown in FIG. 3 the metallization regions 64 of the EMI card 62 shown in FIG. 2A makes electrical contact with an end cap 84 when the main brush card 60 with the EMI card 62 is staked to the end cap 84. In the same manner the metallization region 64 of the EMI card 92 shown in FIG. 2C also makes electrical contact with an end cap 84 when the main brush card 60 is staked to the end cap 84. The staking action squeezes the EMI cards 62 or 92 between the end cap casting 84 and the main brush card 60, insuring solid, constant contact between the EMI cards 62 or 92 and the casting surface of the end cap 84.

FIG. 2B is FIG. 2A with the EMI card 62 replaced by an EMI card 86. The EMI card 86 has two metallization regions 88 and 90, each of which has a through hole for the rivets 70 and 72, respectively. The EMI card 86, unlike the EMI card 62, does not have the metallization region 64 of FIGS. 2A and 2C that makes contact with the end cap 84 when the brush card is staked to the end cap.

FIG. 2C is a perspective view of a bottom portion of the main brush card 60 and another EMI card 92. The EMI card 92 has an extended middle region 94. Metallization regions 96 and 98 are provided on the EMI card 92 which are wider in the center than the metallization regions 66 and 68 on the EMI card 62 to allow placement of the additional two chips 80 and 82 where they can connect metallized regions 96 and 98 to metallized region 64 and not physically interfere with the end cap 84. The EMI suppression device 78 in FIG. 2A has been replaced in FIG. 2C with a lower profile EMI suppression device 100 in this particular embodiment.

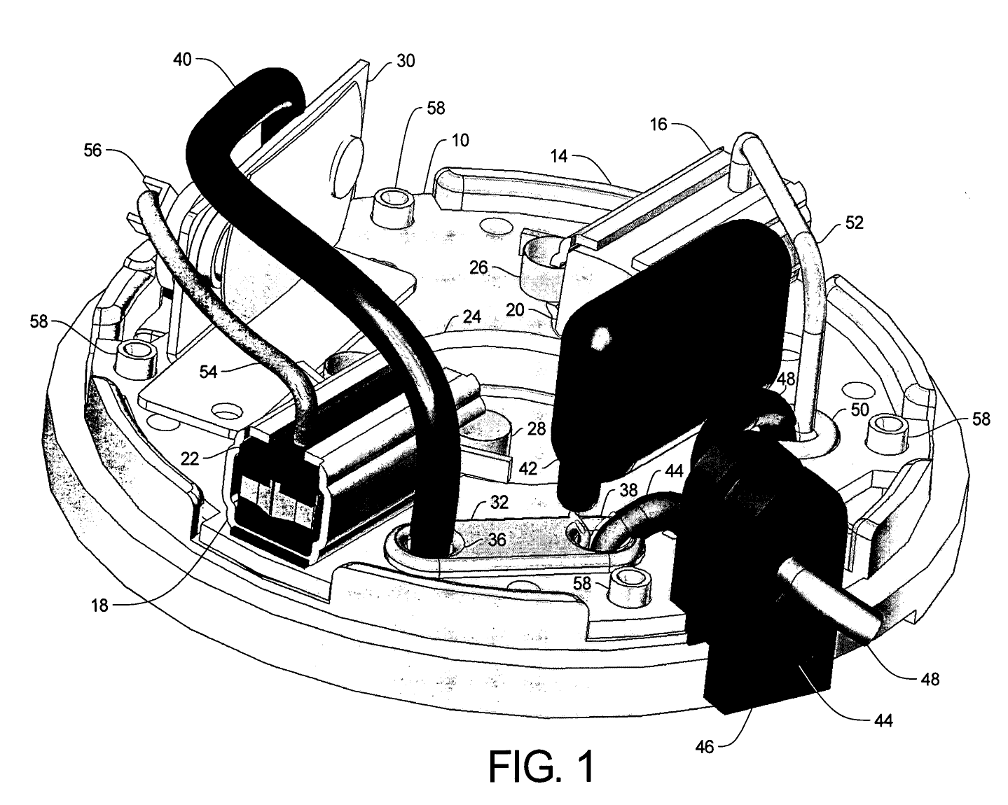

FIG. 3 is a perspective cross section view showing a bottom portion of the main brush card 60 with the EMI card 62 of FIG. 2A mounted in the end cap 84. The end cap 84 has a brush card support surface 106 and a recess 108 for the EMI cards 62 and 92. The depth of the recess 108 is such that a bottom surface 110 of the recess 108 contacts the region 64 of the EMI cards 62 or 92 when the end cap 84 is staked to the main brush card 60 thus providing the motor chassis electrical potential to region 64. While FIG. 3 shows the EMI card 62 with only the one EMI suppressor device 78, the EMI card 92 with two additional EMI suppressor devices as shown in FIG. 2C could be used in place of the EMI card 62 shown in FIG. 2A. In addition the EMI card 86 of FIG. 2B could also be used in place of the EMI card 62 shown in FIG. 3 in which case there would be no electrical contact between the end cap 84 and the EMI card 62. Thus, a motor manufacturer has the ability to attach almost any level of EMI suppression (or no suppression) to the same brush card without tooling or setup changes. In addition, mounting the EMI card to the underside of the brush card assembly frees up space on the topside of the brush card for wire routing. Moreover, the assembly is solder-free, less complicated, and the grounding is more reliable than in the brush card assembly of FIG. 1.

As shown in FIG. 3 the brass terminal 76 includes a tab 112 which extends into one of a plurality of openings 114 in the main brush card 60, the openings 114 used to stabilize the brass terminals such as brass terminal 76.

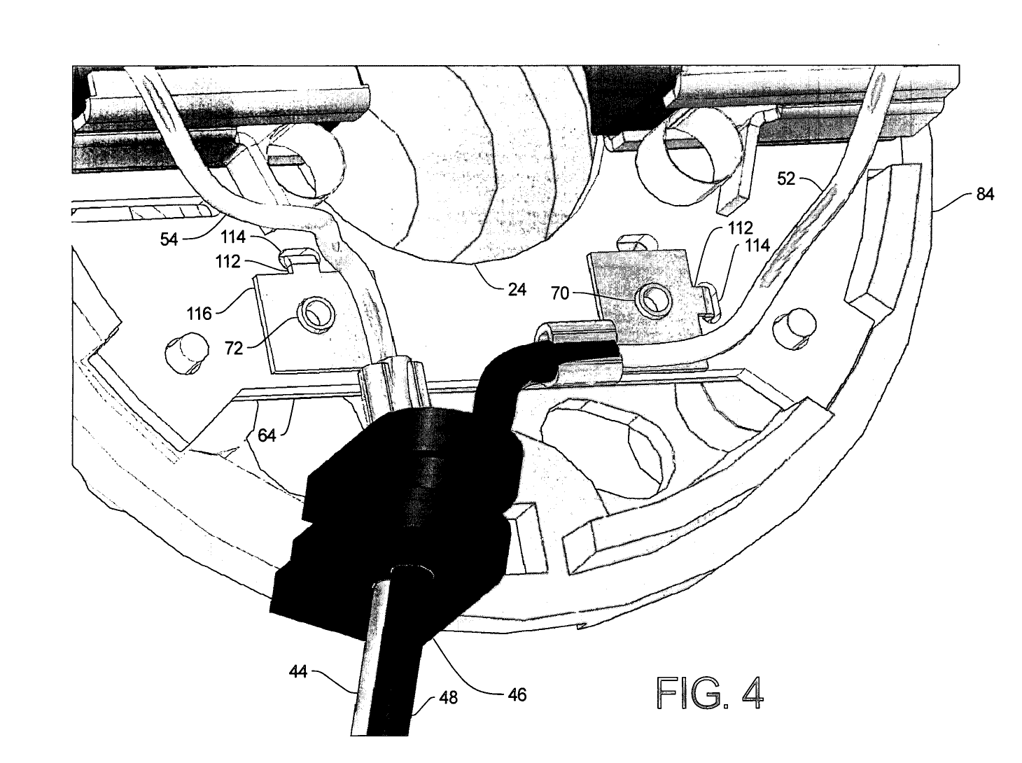

FIG. 4 is a perspective view showing an upper portion of the brush card shown in any of the FIGS. 2A-2C. In additional to brass terminal 76, brass terminal 116 is used to crimp the power input wire 44 to the brush pig tail 54. Brass terminals 76 and 116 are the same terminals that have been oriented differently on the brush card 60. The brass terminals 76 and 116 eliminate the solder junctions of FIG. 1 and also provide a relatively thick metal surface for attaching one end of the rivets 70 and 72 to the EMI card 64.

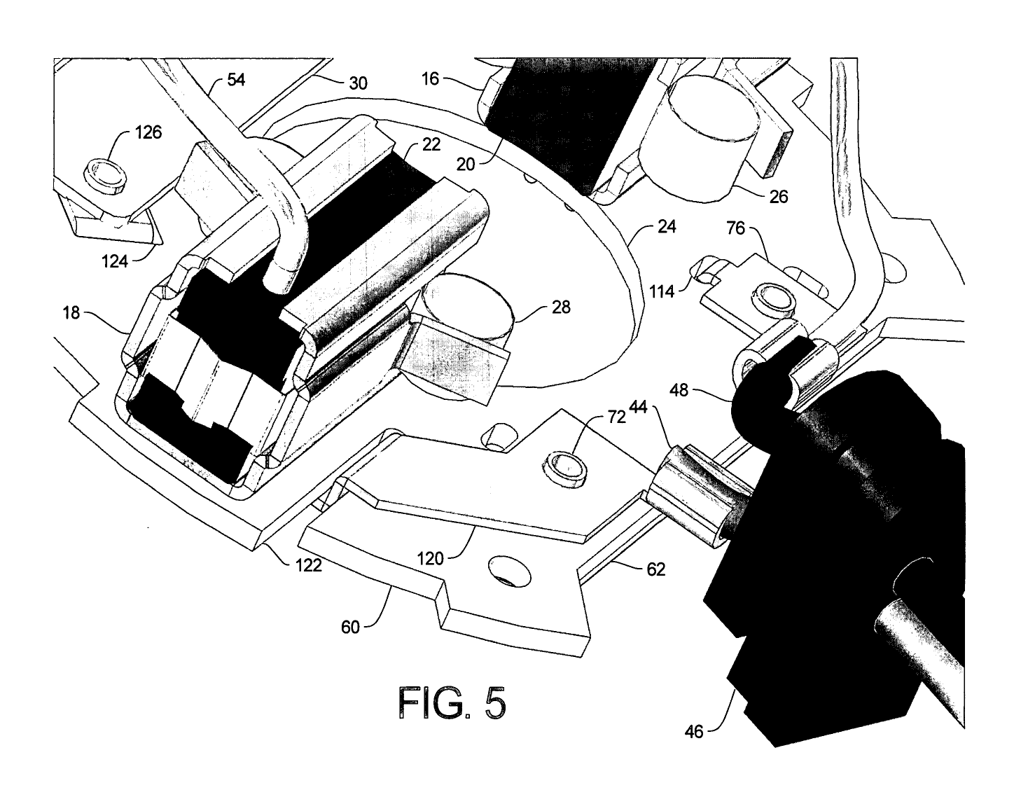

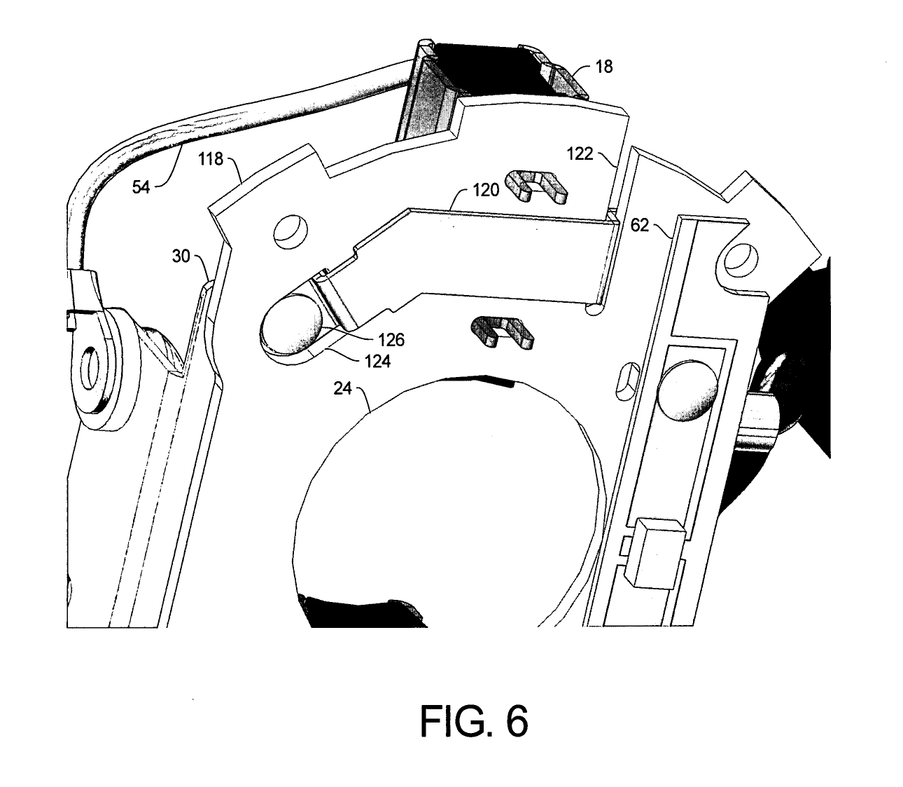

FIGS. 5 and 6 are perspective views showing an upper portion and a lower portion, respectively, of main brush card 60 with the brass terminal 116 of FIG. 4 replaced with a brass terminal strip jumper 120 which passes through a slot 122 in the main brush card 60, extends below the brush holder 18, then jogs up into an opening 124 in the main brush card 60, and connects to the circuit breaker 30 by a rivet 126 thus eliminating the wire 40 shown in FIG. 1.

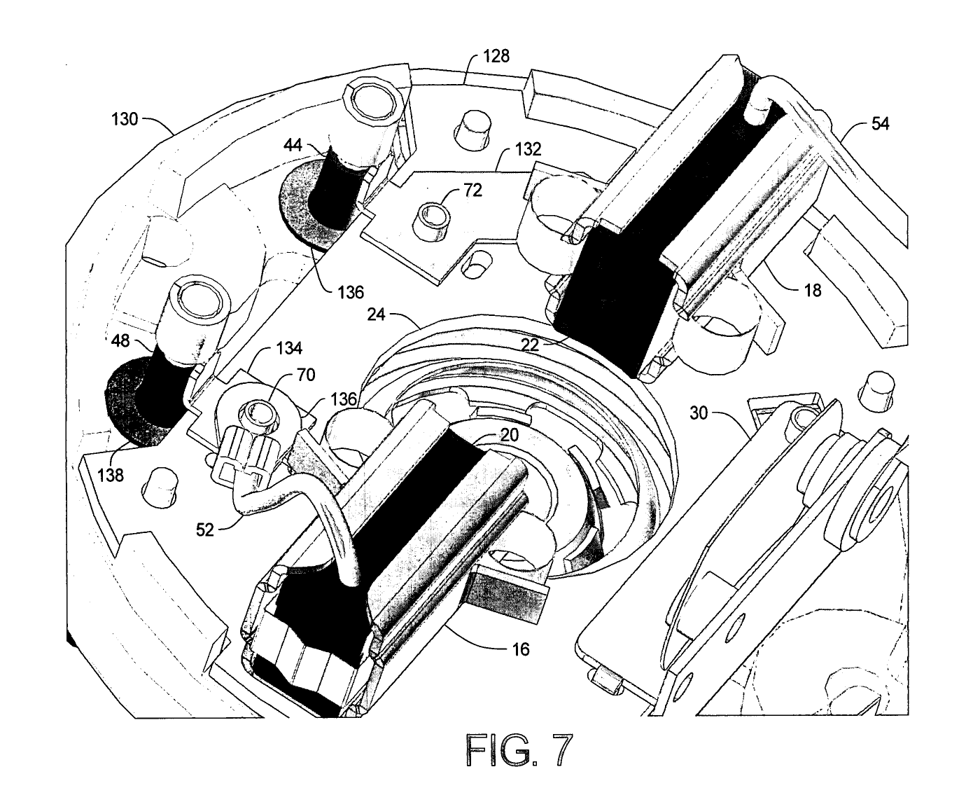

FIG. 7 is a perspective view showing the upper portion of a third main brush card assembly 128, the EMI card 62 of FIG. 2A, and an alternative end cap 130. In this embodiment the two power input wires 44 and 48 are routed through the bottom of the end cap 130 and crimped to two brass terminals 132 and 134, respectively. The rubber grommet 46 has been replaced with two individual waterproof grommets 136 and 138 around the power input wires 44 and 48, respectively. The brass terminals 132 and 134 are crimped around a single wire rather than two wires thus simplifying the wire crimping operation. A ring terminal 136 attached to the brush pigtail 52 is connected to the terminal 134 by the rivet 70. Any of the EMI cards shown in FIGS. 2A-2C can be used with this brush card assembly 128 and end cap 130.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims. For example, the additional card, instead of being an EMI card, or in addition, could be used to mount an over voltage protection device.

What is claimed is:

1. A brush card assembly comprising:
a) a main brush card having a plurality of brush holders attached to the top of said main brush card; and
b) an additional board attached to the bottom of said main brush card.

2. The brush card assembly of claim 1 wherein input power wires to said main brush card are electrically coupled to said additional board.

3. The brush card assembly of claim 1 wherein said additional board has a plurality of conductive regions.

4. The brush card assembly of claim 3 wherein said plurality of conductor regions includes three conductive regions.

5. The brush card assembly of claim 3 wherein one of said conductive regions makes electrical contact to a metallic portion of a structure in contact with said main brush card.

6. The brush card assembly of claim 1 wherein an EMI suppressor device is attached to said additional board.

7. The brush card assembly of claim 1 wherein a plurality of EMI suppressor devices are attached to said additional board.

8. The brush card assembly of claim 2 wherein said power leads are each crimped together with at least one additional wire.

9. The brush card assembly of claim 1 wherein said main brush card and said additional board are riveted together.

10. The brush card assembly of claim 1 further including at least one metallic terminal having a region which can be crimped around a conductor in an input power wire to said main brush card and which has an opening for riveting said metallic terminal to said main brush card.

11. The brush card assembly of claim 6 wherein said EMI suppression device is a two terminal device.

12. The brush card assembly of claim 10 wherein said metallic terminal is a metallic strip jumper, at least a portion of which is situated below said main brush card and which provides a connection to an additional device attached to the top of said main brush card wherein at least one of said plurality of brush holders are positioned between said additional device and said region which can be crimped.

13. A method of providing EMI suppression to an electrical motor comprising the steps of:
a) attaching an electrical device to a circuit board having a plurality of conductive regions; and
b) attaching said circuit board to the bottom of a main brush card in a manner to couple the input power voltage to the motor present on said main brush card to said circuit board.

14. The method of claim 13 wherein said circuit board is attached to said main brush card in a manner such that one of said conductive regions makes electrical contact with a metallic support member for said main brush card.

15. The method of claim 13 wherein said step of attaching is performed by riveting said circuit board to said main brush card.
